(19) United States
(12) Patent Application Publication
(10) Pub. No.: US 2014/0343903 A1
(43) Pub. Date: Nov. 20, 2014

(54) FACTORIAL HIDDEN MARKOV MODELS ESTIMATION DEVICE, METHOD, AND PROGRAM

(71) Applicant: NEC CORPORATION, Tokyo (JP)

(72) Inventors: Ryohei FUJIMAKI, Tokyo (JP); Shaohua LI, Tokyo (JP)

(73) Assignee: NEC CORPORATION, Tokyo (JP)

(21) Appl. No.: 13/898,087

(22) Filed: May 20, 2013

(51) Int. Cl. G06F 17/16

(52) U.S. Cl. CPC G06F 17/16
USPC 703/2

(57) ABSTRACT

An approximate computation unit computes an approximate of a determinant of a Hessian matrix relating to a parameter of an observation model represented as a linear combination of parameters determined by each layer 1 latent variable of factorial hidden Markov models. A variational probability computation unit computes a variational probability of a latent variable using the approximate of the determinant. A latent state removal unit removes a latent state based on a variational distribution. A parameter optimization unit optimizes the parameter for a criterion value that is defined as a lower bound of an approximate obtained by Laplace-approximating a marginal log-likelihood function with respect to an estimator for a complete variable, and computes the criterion value. A convergence determination unit determines whether or not the criterion value has converged.

### BACKGROUND OF THE INVENTION

1. Field of the Invention

The present invention relates to a factorial hidden Markov models estimation device, a factorial hidden Markov models estimation method, and a factorial hidden Markov models estimation program, and especially relates to a factorial hidden Markov models estimation device, a factorial hidden Markov models estimation method, and a factorial hidden Markov models estimation program for estimating factorial hidden Markov models by approximating model posterior probabilities and maximizing their lower bounds.

2. Description of the Related Art

Data exemplified by sensor data acquired from cars, medical examination value records, electricity demand records, and the like are all multivariate data having “time dependence”. Analysis of such data is applied to many industrially important fields. For example, by analyzing sensor data acquired from cars, it is possible to analyze causes of car troubles and effect quick repairs. Moreover, by analyzing medical examination value records, it is possible to estimate disease risks and prevent diseases. Furthermore, by analyzing electricity demand records, it is possible to predict electricity demand and prepare for an excess or shortage.

Latent variable models (e.g. hidden Markov models) having time dependence are typically used to model such data. For instance, in order to use hidden Markov models, it is necessary to determine the number of latent states, the type of observation probability distribution, and distribution parameters. In the case where the number of latent states and the type of observation probability distribution are known, the parameters can be estimated through the use of an expectation maximization algorithm (for example, see Non-Patent Document 1).

In hidden Markov models, it is assumed that observations are obtained independently for one latent state (in other words, latent states are time-dependent). However, in various situations of practical application, there are cases where this assumption does not hold. That is, there are cases where observations are obtained by superposition of a plurality of latent states. For example, in speech recognition, there is a latent state for each person in speech data of a situation where a plurality of persons are speaking. Speech observed then is superposition of observations from each latent state. That is, voices of the plurality of persons are mixed in the observed speech. Moreover, consider an example of estimating human activities from sensor responses observed in a building in which a plurality of infrared sensors are installed. A sensor response represents human position information. In the case where a plurality of persons act in the building, human activities (latent states) transition in time. Then, infrared sensor responses (observations) are determined by superposition of activities of the plurality of persons.

Factorial hidden Markov models are proposed in order to handle such complex sequential data (for example, see Non-Patent Document 2). In factorial hidden Markov models, time transitions of a plurality of latent states are taken into account, and parameters of observation models are determined depending on each latent state.

In factorial hidden Markov models, there are higher (layer 1) latent states which transition in time independently and lower (layer 2) latent states which represent states for each layer 1 latent variable.

The problem of determining the number of latent states is commonly referred to as “model selection problem” or “system identification problem”, and is an extremely important problem for constructing reliable models. Various techniques for this are proposed.

As a method for determining the number of latent states, for example, a method of maximizing variational free energy by a variational Bayesian method is proposed in Non-Patent Document 2. This method is hereafter referred to as the first known technique.

As another method for determining the number of latent states, for example, a nonparametric Bayesian method using a hierarchical Dirichlet process prior distribution is proposed in Non-Patent Document 3. This method is hereafter referred to as the second known technique.

In hidden Markov models, latent variables have time dependence, and parameters are independent of latent variables. As a technique applied to hidden Markov models, a technique called factorized asymptotic Bayesian inference is proposed in Non-Patent Document 4. This technique is superior to the variational Bayesian method and the nonparametric Bayesian method, in terms of speed and accuracy.

In mixture distribution models, latent variables do not have time dependence. Factorized asymptotic Bayesian inference for mixture distribution models is proposed in Non-Patent Document 5.

In addition, approximating a complete marginal likelihood function and maximizing its lower bound is described in Non-Patent Document 4 and Non-Patent Document 5.

### CITATION LIST

### Non-Patent Literature

Non-Patent Document 1: C. Bishop, “Pattern Recognition and Machine Learning”, Springer, 2007.
Non-Patent Document 2: Ghahramani, Zoubin; Jordan, Michael I. (1997), “Factorial Hidden Markov Models”, Machine Learning 29 (2/3): 245-273.
Non-Patent Document 3: J. V. Gael, Y. W. Teh, and Z. Ghahramani, “The infinite factorial hidden Markov model”, In Neural Information Processing Systems (NIPS), 2008.
Non-Patent Document 4: Ryohei Fujimaki, Kohei Hayashi, “Factorized Asymptotic Bayesian Hidden Markov Models”, Proceedings of the 25th international conference on machine learning (ICML), 2012.
Non-Patent Document 5: Ryohei Fujimaki, Satoshi Morinaga, “Factorized Asymptotic Bayesian Inference for Mixture Modeling”, Proceedings of the fifteenth international conference on Artificial Intelligence and Statistics (AISTATS), 2012.

### SUMMARY OF THE INVENTION

An exemplary object of the present invention is to provide a factorial hidden Markov models estimation device, a factorial hidden Markov models estimation method, and a factorial hidden Markov models estimation program capable of solving the model selection problem for factorial hidden Markov models based on factorized asymptotic Bayesian inference.

An exemplary aspect of the present invention is a factorial hidden Markov models estimation device including: an approximate computation unit for computing an approximate of a determinant of a Hessian matrix relating to a parameter of an observation model represented as a linear combination of parameters determined by each layer 1 latent variable of factorial hidden Markov models; a variational probability computation unit for computing a variational probability of a latent variable using the approximate of the determinant; a latent state removal unit for removing a latent state based on a variational distribution; a parameter optimization unit for optimizing the parameter for a criterion value that is defined as a lower bound of an approximate obtained by Laplace-approximating a marginal log-likelihood function with respect to an estimator for a complete variable, and computing the criterion value; and a convergence determination unit for determining whether or not the criterion value has converged.

An exemplary aspect of the present invention is a factorial hidden Markov models estimation method including: computing an approximate of a determinant of a Hessian matrix relating to a parameter of an observation model represented as a linear combination of parameters determined by each layer 1 latent variable of factorial hidden Markov models; computing a variational probability of a latent variable using the approximate of the determinant; removing a latent state based on a variational distribution; optimizing the parameter for a criterion value that is defined as a lower bound of an approximate obtained by Laplace-approximating a marginal log-likelihood function with respect to an estimator for a complete variable; computing the approximate of the determinant of the Hessian matrix; computing the criterion value; and determining whether or not the criterion value has converged.

An exemplary aspect of the present invention is a computer readable recording medium having recorded thereon a factorial hidden Markov models estimation program for causing a computer to execute: an approximate computation process of computing an approximate of a determinant of a Hessian matrix relating to a parameter of an observation model represented as a linear combination of parameters determined by each layer 1 latent variable of factorial hidden Markov models; a variational probability computation process of computing a variational probability of a latent variable using the approximate of the determinant; a latent state removal process of removing a latent state based on a variational distribution; a parameter optimization process of optimizing the parameter for a criterion value that is defined as a lower bound of an approximate obtained by Laplace-approximating a marginal log-likelihood function with respect to an estimator for a complete variable; a criterion value computation process of computing the criterion value; and a convergence determination process of determining whether or not the criterion value has converged.

### BRIEF DESCRIPTION OF THE DRAWINGS

FIG. 1 is a block diagram showing a structure example of a factorial hidden Markov models estimation device according to the present invention.

FIG. 2 is a flowchart showing an example of a process according to the present invention.

FIG. 3 is a block diagram showing an overview of the present invention.

### DESCRIPTION OF THE PREFERRED EMBODIMENTS

To clarify the contributions of the present invention, the difference between hidden Markov models and factorial hidden Markov models and the problem of why factorized asymptotic Bayesian inference cannot be directly applied to factorial hidden Markov models are described first.

In the following description, it is assumed that a time-dependent data sequence xⁿ (n=1, . . . , N) is input. Here, each xⁿ is a multivariate data sequence (xⁿ=xⁿ¹, . . . , x^{nTn} t=1, . . . , N) having length Tn. Moreover, each x^{nt} is a D-dimensional observation vector, where x^{nt}=(x^{nt}₁, . . . , x^{nt}_{D}). Next, a layer 1 latent variable z^{nt}=(z^{nt1}, . . . , z^{ntK}) corresponding to the observed variable x^{nt} is defined. Here, K is the number of layer 1 latent states.

In hidden Markov models, for the layer 1 latent variable, z^{nt1} is a binary variable, where Σk z^{ntk}=1. That is, only one element of z^{nt} is 1. In hidden Markov models, a joint distribution of xⁿ and zⁿ is represented as p(xⁿ, zⁿ|θ)=Πn p(zⁿ⁰|α) p(xⁿ¹|zⁿ¹, φ) Πₜ₌₂^{Tn} p(z^{nt-1}, β) p(x^{nt}|z^{nt}, φ). Here, θ=(α, β, φ) are respectively parameters of a latent state initial probability, a latent state transition probability, and an observation probability. The observation probability is decomposed as shown in the following Expression 1.

p(x^{nt}|z^{nt},φ)=Πk p(x^{nt}|φₖ)^{zntk} (Expression 1).

Here, φ=(φ1, . . . , φk). The important point is that φk has no dependence relation with k. Because of this property, the Hessian matrix of the joint log-likelihood is block diagonal, enabling the use of the theoretically excellent property of factorized asymptotic Bayesian inference, as described later.

Factorial hidden Markov models are described next. In factorial hidden Markov models, the k-th layer 1 latent variable is represented as a layer 2 latent variable vector z^{ntk}=(z^{ntk}₁, . . . , z^{ntk}_{Mk}). Mk is the number of k-th layer 1 latent states. z^{ntk}ₘ is a binary variable, where Σm z^{ntk}ₘ=1. That is, only one element of z^{ntk} is 1. The principal difference of factorial hidden Markov models from hidden Markov models lies in that the parameter of the observation probability depends on layer 2 latent variables. This is described below, using a normal distribution as an example. Note that the same argument as given below also applies to probability distributions of wider classes such as an exponential family. The parameter of the observation model is represented as a linear combination of parameters determined by each layer 1 latent variable, as shown in the following Expression 2.

p(x^{nt}|z^{nt},φ)=Πd p(x^{nt}_{d}|z^{nt},φ_{d},σ_{d}²)=Πd N(x^{nt}_{d},ΣkΣm z^{ntk}ₘφ^{km}_{d},σ_{d}²) (Expression 2).

Here, the parameter corresponding to the m-th layer 2 latent variable of the k-th layer 1 latent variable is denoted by φkm. Moreover, N(x, a, b) denotes a normal distribution with mean a and covariance b for x. The important point is that the observation distribution of d-th dimension of each sample depends on latent states. In other words, the important point is that the mean of the normal distribution is determined by latent variables. In this model, the Hessian matrix of log p(x^{nt}_{d}|z^{nt}, φ_{d}, σ_{d}²) is not block diagonal and the theoretically excellent property (such as removal of unwanted latent states) of factorized asymptotic Bayesian inference is lost, unlike hidden Markov models.

This is described in more detail below. Though the index n is omitted for notational simplicity, this does not affect the description about the substantial difference between the present invention and Non-Patent Document 4. First, in the present invention, the model and parameters are optimized by maximizing the marginal log-likelihood according to Bayesian inference. Here, since it is difficult to directly optimize the marginal log-likelihood, the marginal log-likelihood is first modified as shown in the following Expression 3.

log p(x|M)=max_{—}q(z)log p(x,z|M)/q(z) (Expression 3).

Here, M is the model, and q(z) is the variational distribution for z. Moreover, max_q denotes the maximum value for q. The joint marginal likelihood p(x, z|M) can be modified as shown in the following Expression 4, in integral form for parameters.

[Math. 1]

p(x,z|M)=∫p(x,z|θ)p(θ|M)dθ (Expression 4)

The following description is made while limiting to observation models where hidden Markov models and factorial hidden Markov models are substantially different. Since N does not affect the difference between hidden Markov models and factorial hidden Markov models, all notations relating to N and n are omitted in the following.

First, in hidden Markov models, log p(x^{t}|z^{t}, φ)=Σkz^{tk} log p(x^{t}|φₖ), according to Expression 1. By Taylor-expanding each term around the maximum likelihood estimator φ′ and ignoring terms of third or higher order, log p(x|z, φ) is approximated as shown in the following Expression 5.

[Math. 2]

log p(px|z,φ)≠log p(x|z,φ′)−Σk 0.5(Σt,z^{tk})(φk−φk′)Fk(φk−φk′) (Expression 5)

Expression 5 above corresponds to the observation-related terms in Expression (3) in Non-Patent Document 4. Here, Fk is a matrix obtained by dividing the Hessian matrix of p(x^{t}|φₖ) by (Σt z^{tk}), and is a block diagonal term of the Hessian matrix of p(x, z|θ). When computing the integral of Expression 4 with regard to the approximation of Expression 5, the related terms are as shown in the following Expression 6. The result of applying exp to both sides and removing log in the left side corresponds to the observation-related terms in Expression (5) in Non-Patent Document 4.

log p(x|z,φ′)+Σk 0.5(Dk log 2π−Dk log(Σt z^{tk})−log det(Fk)) (Expression 6).

Here, det denotes the determinant of the argument, and Dk denotes the dimension of φk. When taking the limit of T into consideration, log 2π and log det(Fk) are relatively small and so can be ignored. Hence, Expressions (6) and (7) in Non-Patent Document 4 are obtained as the optimization criterion.

Note that T is the length of data (sequence length of sequence data).

Next, in factorial latent variable models, p(x^{t}_{d}|z^{t}, φ_{d})=N(x^{t}_{d}, ΣkΣm z^{tk}ₘφ^{km}_{d}, σ_{d}²), according to Expression 2. By Taylor-expanding each term around the maximum likelihood estimator φ′ and ignoring terms of third or higher order, log p(x_{d}|z, φ) is approximated as shown in the following Expression 7.

[Math. 3]

log p(x_{d}|z,φ)≠log p(x_{d}|z,φ′)−0.5 T(φ_{d}−φ_{d}′)Fd(φ_{d}−φ_{d}′) (Expression 7)

Here, Fd is a matrix obtained by dividing the Hessian matrix of Σt log p(x^{t}_{d}|z^{t}, φ_{d}) by T. When computing the integral of Expression 4 with regard to the approximation of Expression 7, the related terms are as shown in the following Expression 8.

log p(x_{d}|z,φ′)+0.5(Dd log 2π−Dd log T−log det(Fd)) (Expression 8).

The substantial difference between the case of hidden Markov models (Expression 6) and the case of factorial hidden Markov models (Expression 8) is that the term “Dk log(Σt z^{tk})” in Expression 6 is “Dd log N” in Expression 8 where the model complexity does not depend on latent variables. This is described in more detail below. Factorized asymptotic Bayesian inference for hidden Markov models proposed in Non-Patent Document 4 has the theoretically excellent property such as removal of unwanted latent states, because the model complexity depends on latent variables. This point is explained in, for example, “Section 4.4 Automatic Hidden State Selection” in Non-Patent Document 4. However, such a property is lost in Expression 8 obtained by applying the procedure in Non-Patent Document 4 to factorial hidden Markov models.

The substantial difference of the present invention from the technique described in Non-Patent Document 4 lies in the process of approximating log det(Fd). In the procedure described in Non-Patent Document 4, log det(Fd) in Expression 8 is, as being asymptotically small, approximated as follows.

[Math. 4]

log det(Fd)≠0

On the other hand, in the present invention, log det(Fd) is approximated as shown in the following Expression 9. In detail, the below-mentioned information criterion approximation unit 105 included in a factorial hidden Markov models estimation device according to the present invention approximates log det(Fd) by Expression 9.

[Math. 5]

log det(Fd)≠ΣkΣm log(Σt z^{tk}ₙ)−Dd log T (Expression 9)

The important point in this process is that log det(Fd), which is ignored in the process described in Non-Patent Document 4, depends on latent variables. Note that T is equal to the infinite limit in the approximation in Expression 9. In the approximation in Non-Patent Document 4 as shown in the following expression, the model complexity is underestimated.

[Math. 6]

log det(Fd)≠0

In the present invention, by performing the approximation shown in Expression 9, model selection having the theoretically excellent property such as removal of unwanted latent states can be achieved for factorial latent variable models.

The following describes an embodiment of the present invention with reference to drawings.

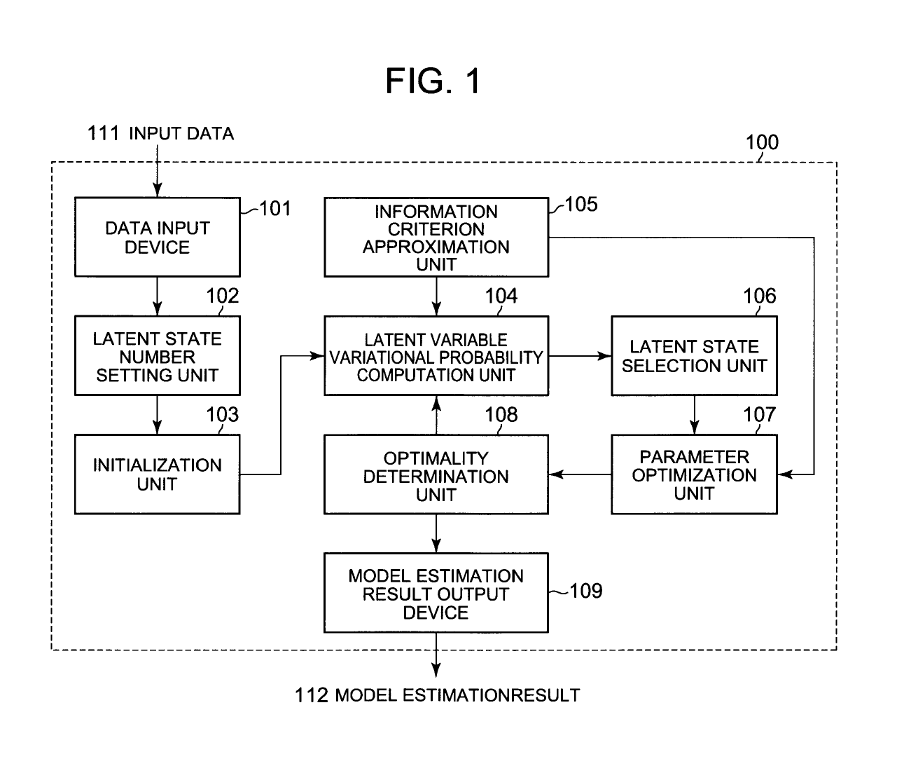

FIG. 1 is a block diagram showing a structure example of a factorial hidden Markov models estimation device according to the present invention. A factorial hidden Markov models estimation device 100 according to the present invention includes a data input device 101, a latent state number setting unit 102, an initialization unit 103, a latent variable variational probability computation unit 104, an information criterion approximation unit 105, a latent state selection unit 106, a parameter optimization unit 107, an optimality determination unit 108, and a model estimation result output device 109. Input data 111 is input to the factorial hidden Markov models estimation device 100. The factorial hidden Markov models estimation device 100 optimizes factorial hidden Markov models for the input data 111 and outputs the result as a model estimation result 112.

The data input device 101 is a device for inputting the input data 111. The parameters necessary for model estimation, such as the type of observation probability and the candidate value for the number of latent states, are simultaneously input to the data input device 101 as the input data 111.

The latent state number setting unit 102 sets the number K of layer 1 latent states of the model, to a maximum value Kmax input as the input data 111. The latent state number setting unit 102 also sets the number Mk of layer 2 latent states, to a maximum value Mmax input as the input data 111. That is, the latent state number setting unit 102 sets K=Kmax and Mk=Mmax.

The initialization unit 103 performs an initialization process for estimation. The initialization may be executed by an arbitrary method. Examples of the method include: a method of randomly setting the parameter θ of each observation probability; and a method of randomly setting the variational probability of the latent variable.

The latent variable variational probability computation unit 104 computes the variational probability of the latent variable. Since the parameter θ has been computed by the initialization unit 103 or the parameter optimization unit 107, the latent variable variational probability computation unit 104 uses the computed value. The latent variable variational probability computation unit 104 computes the variational probability, by maximizing an optimization criterion A defined as follows. The optimization criterion A is defined as a lower bound of an approximate obtained by Laplace-approximating a marginal log-likelihood function with respect to an estimator (e.g. maximum likelihood estimator or maximum posterior probability estimator) for a complete variable.

The information criterion approximation unit 105 performs an approximation process of the determinant of the Hessian matrix, which is necessary for the latent variable variational probability computation unit 104 and the parameter optimization unit 107. In detail, the information criterion approximation unit 105 performs the approximate computation according to Expression 9 mentioned earlier.

The latent state selection unit 106 removes small states of latent states, from the model. In detail, in the case where, for the k-th latent state, Σn Σt q(z^{ntk}ₘ) is below a threshold set as the input data 111, the latent state selection unit 106 removes the m-th layer 2 latent state from the model. Moreover, in the case where the number of layer 2 latent states is 1, the latent state selection unit 106 removes the layer 1 latent state.

The parameter optimization unit 107 optimizes θ for the optimization criterion A, after fixing the variational probability of the latent variable. Note that the term relating to θ of the optimization criterion A is a joint log-likelihood function weighted by the variational distribution of latent states, and can be optimized according to an arbitrary optimization algorithm. For instance, in the normal distribution in the above-mentioned example, the parameter optimization unit 107 can optimize the parameter according to mean field approximation. In addition, the parameter optimization unit 107 simultaneously computes the optimization criterion A for the optimized parameter. When doing so, the parameter optimization unit 107 uses the approximate computation by the information criterion approximation unit 105 mentioned above. That is, the parameter optimization unit 107 uses the approximation result of the determinant of the Hessian matrix by Expression 9.

The optimality determination unit 108 determines the convergence of the optimization criterion A. The convergence can be determined by setting a threshold for the amount of absolute change or relative change of the optimization criterion A and using the threshold.

The model estimation result output device 109 outputs the optimal number of latent states, observation probability parameter, variational distribution, and the like, as the model estimation result output result 112.

The latent state number setting unit 102, the initialization unit 103, the latent variable variational probability computation unit 104, the information criterion approximation unit 105, the latent state selection unit 106, the parameter optimization unit 107, and the optimality determination unit 108 are realized, for example, by a CPU of a computer operating according to a factorial hidden Markov models estimation program. In this case, the CPU may read the factorial hidden Markov models estimation program and, according to the program, operate as the latent state number setting unit 102, the initialization unit 103, the latent variable variational probability computation unit 104, the information criterion approximation unit 105, the latent state selection unit 106, the parameter optimization unit 107, and the optimality determination unit 108. The factorial hidden Markov models estimation program may be stored in a computer readable recording medium. Alternatively, each of the above-mentioned components 102 to 108 may be realized by separate hardware.

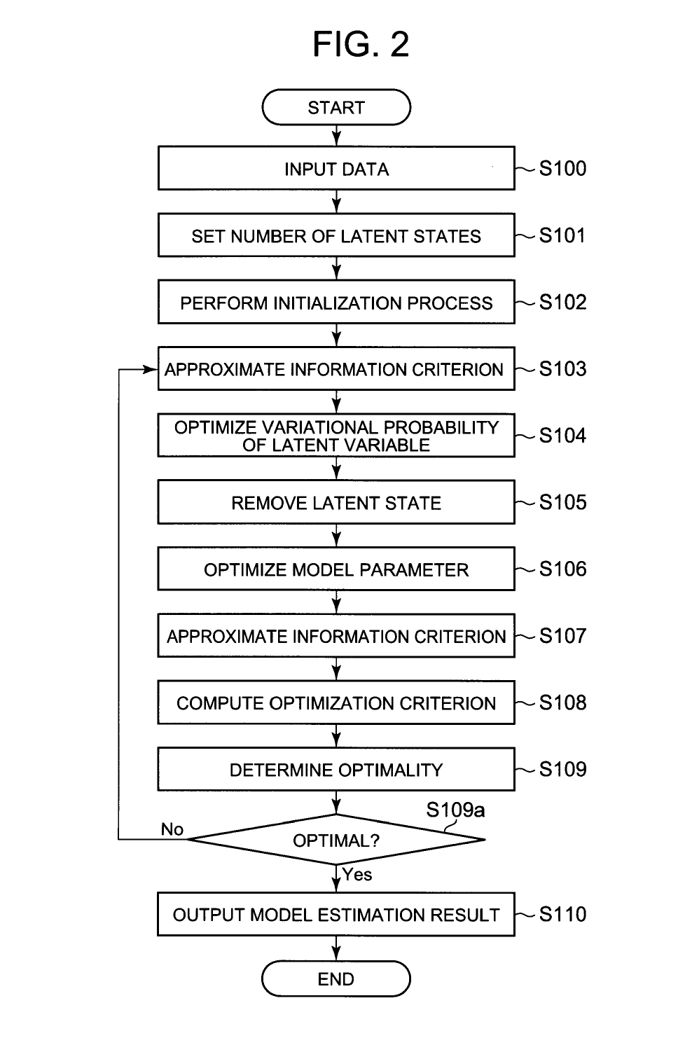

FIG. 2 is a flowchart showing an example of a process according to the present invention. The input data 111 is input via the data input device 101 (step S100).

Next, the latent state number setting unit 102 sets the maximum value of the number of latent states input as the input data 111, as the initial value of the number of latent states (step S101). That is, the latent state number setting unit 102 sets the number K of layer 1 latent states of the model, to the input maximum value Kmax. The latent state number setting unit 102 also sets the number Mk of layer 2 latent states, to the input maximum value Mmax.

Next, the initialization unit 103 performs the initialization process of the variational probability of the latent variable and the parameter for estimation (e.g. the parameter θ of each observation probability), for the designated number of latent states (step S102).

Next, the information criterion approximation unit 105 performs the approximation process of the determinant of the Hessian matrix (step S103). The information criterion approximation unit 105 computes the approximate of the determinant of the Hessian matrix through the computation of Expression 9.

The latent variable variational probability computation unit 104 computes the variational probability of the latent variable using the computed approximate of the determinant of the Hessian matrix (step S104).

Next, the latent state selection unit 106 removes any unwanted latent state from the model, based on the above-mentioned threshold determination (step S105). That is, in the case where, for the k-th latent state, Σn Σt q(z^{ntk}ₘ) is below the threshold set as the input data 111, the latent state selection unit 106 removes the m-th layer 2 latent state from the model of the state. Moreover, in the case where the number of layer 2 latent states is 1, the latent state selection unit 106 removes the layer 1 latent state.

Next, the parameter optimization unit 107 computes the parameter for optimizing the optimization criterion A (step S106). For example, the optimization criterion A used the first time the parameter optimization unit 107 executes step S106 may be randomly set by the initialization unit 103. As an alternative, the initialization unit 103 may randomly set the variational probability of the latent variable, with step S106 being omitted in the first iteration of the loop process of steps S103 to S109a (see FIG. 2).

Next, the information criterion approximation unit 105 performs the approximation process of the determinant of the Hessian matrix (step S107). The information criterion approximation unit 105 computes the approximate of the determinant of the Hessian matrix through the computation of Expression 9.

Next, the parameter optimization unit 107 computes the value of the optimization criterion A, using the parameter optimized in step S106 (step S108).

Next, the optimality determination unit 108 determines whether or not the optimization criterion A has converged (step S109). For example, the optimality determination unit 108 may compute the difference between the optimization criterion A obtained by the most recent iteration of the loop process of steps S103 to S109a and the optimization criterion A obtained by the iteration of the loop process of steps S103 to S109a immediately preceding the most recent iteration, and determine that the optimization criterion A has converged in the case where the absolute value of the difference is less than or equal to a predetermined threshold, and that the optimization criterion A has not converged in the case where the absolute value of the difference is greater than the threshold.

In the case of determining that the optimization criterion A has not converged (step S109a: No), the factorial hidden Markov models estimation device 100 repeats the process from step S103. In the case of determining that the optimization criterion A has converged (step S109a: Yes), the model estimation result output device 109 outputs the model estimation result, thus completing the process (step S110). In step S110, the model estimation result output device 109 outputs the number of latent states at the time when it is determined that the optimization criterion A has converged, and the parameter and variational distribution obtained at the time.

The following describes an example of application of the factorial latent variable model estimation device proposed in the present invention, using the case of estimating human activities from position sensors installed in a building as an example. In this example, consider D-dimensional sensor response time series, as x. In the case of estimating human activities (e.g. eating, sleeping, being away) from such data, if there is one person in the building, human activities can be extracted as latent states of hidden Markov models. If there are a plurality of persons in the building, on the other hand, the position of each person is simultaneously observed. Modeling by factorial hidden Markov models is appropriate in such a case. Here, layer 1 latent states of factorial hidden Markov models correspond to persons, and layer 2 latent states correspond to activities. By estimating factorial hidden Markov models according to the present invention, it is possible to automatically extract the number of persons acting (the number of layer 1 latent states) and the activity of each person (layer 2 latent state) from the data.

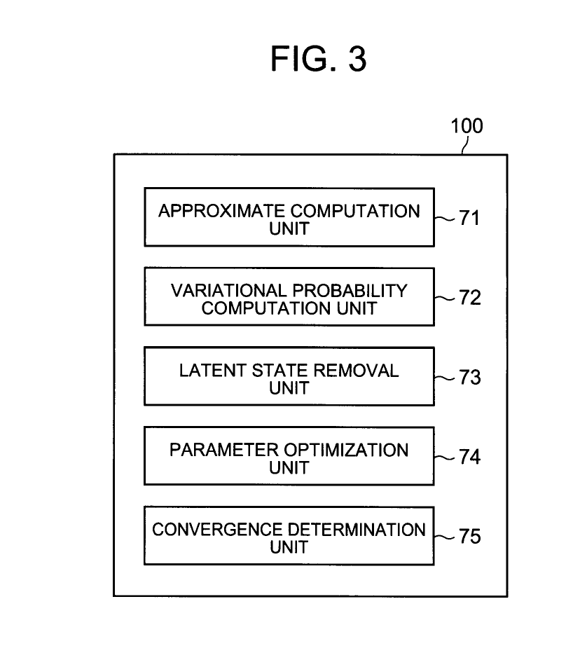

The following describes an overview of the present invention. FIG. 3 is a block diagram showing the overview of the present invention. The factorial hidden Markov models estimation device 100 according to the present invention includes an approximate computation unit 71, a variational probability computation unit 72, a latent state removal unit 73, a parameter optimization unit 74, and a convergence determination unit 75.

The approximate computation unit 71 (e.g. the information criterion approximation unit 105) computes an approximate of a determinant of a Hessian matrix relating to a parameter of an observation model represented as a linear combination of parameters determined by each layer 1 latent variable of factorial hidden Markov models (e.g. performs the approximate computation of Expression 9).

The variational probability computation unit 72 (e.g. the latent variable variational probability computation unit 104) computes a variational probability of a latent variable using the approximate of the determinant.

The latent state removal unit 73 (e.g. the latent state selection unit 106) removes a latent state based on a variational distribution.

The parameter optimization unit 74 (e.g. the parameter optimization unit 107) optimizes the parameter for a criterion value (e.g. the optimization criterion A) that is defined as a lower bound of an approximate obtained by Laplace-approximating a marginal log-likelihood function with respect to an estimator for a complete variable, and computes the criterion value.

The convergence determination unit 75 (e.g. the optimality determination unit 108) determines whether or not the criterion value has converged.

Moreover, it is preferable that a loop process in which the approximate computation unit 71 computes the approximate of the determinant of the Hessian matrix, the variational probability computation unit 72 computes the variational probability of the latent variable, the latent state removal unit 73 removes the latent state, the parameter optimization unit 74 optimizes the parameter, the approximate computation unit 71 computes the approximate of the determinant of the Hessian matrix, the parameter optimization unit 74 computes the criterion value, and the convergence determination unit 75 determines whether or not the criterion value has converged is repeatedly performed until the convergence determination unit 75 determines that the criterion value has converged.

In the first known technique, the independence of latent states and distribution parameters in the variational distribution is assumed when maximizing the lower bound of the marginal likelihood function. The first known technique therefore has the problem of poor marginal likelihood approximation accuracy.

The second known technique has the problem of extremely high computational complexity due to model complexity, and the problem that the number of layer 1 latent states and the number of layer 2 latent states cannot be estimated simultaneously. The second known technique also has the problem that the result varies significantly depending on the input parameters.

In the techniques described in Non-Patent Document 4, Non-Patent Document 5, and so on, substantially the independence of parameters with respect to latent variables is important. Therefore, factorized asymptotic Bayesian inference cannot be directly applied to models in which parameters have dependence relations with latent variables, such as factorial hidden Markov models.

According to the present invention, it is possible to solve the model selection problem for factorial hidden Markov models based on factorized asymptotic Bayesian inference.

What is claimed is:

1. A factorial hidden Markov models estimation device comprising:
an approximate computation unit for computing an approximate of a determinant of a Hessian matrix relating to a parameter of an observation model represented as a linear combination of parameters determined by each layer 1 latent variable of factorial hidden Markov models;
a variational probability computation unit for computing a variational probability of a latent variable using the approximate of the determinant;
a latent state removal unit for removing a latent state based on a variational distribution;
a parameter optimization unit for optimizing the parameter for a criterion value that is defined as a lower bound of an approximate obtained by Laplace-approximating a marginal log-likelihood function with respect to an estimator for a complete variable, and computing the criterion value; and
a convergence determination unit for determining whether or not the criterion value has converged.

2. The factorial hidden Markov models estimation device according to claim 1, wherein a loop process in which the approximate computation unit computes the approximate of the determinant of the Hessian matrix, the variational probability computation unit computes the variational probability of the latent variable, the latent state removal unit removes the latent state, the parameter optimization unit optimizes the parameter, the approximate computation unit computes the approximate of the determinant of the Hessian matrix, the parameter optimization unit computes the criterion value, and the convergence determination unit determines whether or not the criterion value has converged is repeatedly performed until the convergence determination unit determines that the criterion value has converged.

3. A factorial hidden Markov models estimation method comprising:
computing an approximate of a determinant of a Hessian matrix relating to a parameter of an observation model represented as a linear combination of parameters determined by each layer 1 latent variable of factorial hidden Markov models;
computing a variational probability of a latent variable using the approximate of the determinant;
removing a latent state based on a variational distribution;
optimizing the parameter for a criterion value that is defined as a lower bound of an approximate obtained by Laplace-approximating a marginal log-likelihood function with respect to an estimator for a complete variable;
computing the approximate of the determinant of the Hessian matrix;
computing the criterion value; and
determining whether or not the criterion value has converged.

4. The factorial hidden Markov models estimation method according to claim 3, wherein a loop process of computing the approximate of the determinant of the Hessian matrix, computing the variational probability of the latent variable, removing the latent state, optimizing the parameter, computing the approximate of the determinant of the Hessian matrix, computing the criterion value, and determining whether or not the criterion value has converged is repeatedly performed until the criterion value converges.

5. A computer readable recording medium having recorded thereon a factorial hidden Markov models estimation program for causing a computer to execute:
an approximate computation process of computing an approximate of a determinant of a Hessian matrix relating to a parameter of an observation model represented as a linear combination of parameters determined by each layer 1 latent variable of factorial hidden Markov models;
a variational probability computation process of computing a variational probability of a latent variable using the approximate of the determinant;
a latent state removal process of removing a latent state based on a variational distribution;
a parameter optimization process of optimizing the parameter for a criterion value that is defined as a lower bound of an approximate obtained by Laplace-approximating a marginal log-likelihood function with respect to an estimator for a complete variable;
a criterion value computation process of computing the criterion value; and
a convergence determination process of determining whether or not the criterion value has converged.

6. The computer readable recording medium having recorded thereon the factorial hidden Markov models estimation program according to claim 5 for causing the computer to repeatedly execute a loop process of the approximate computation process, the variational probability computation process, the latent state removal process, the parameter optimization process, the approximate computation process, the criterion value computation process, and the convergence determination process, until the criterion value is determined to have converged.
